(19) United States
(12) Patent Application Publication
(10) Pub. No.: US 2020/0339012 A1
(43) Pub. Date: Oct. 29, 2020

(54) PROFILE SELECTION FOR DYNAMIC SAFETY

(71) Applicant: LEAR CORPORATION, Southfield, MI (US)

(72) Inventors: MLADEN HUMER, West Bloomfield, MI (US); ARJUN YETUKURI, Rochester Hills, MI (US); MICHAEL EASTON, Southfield, MI (US); JASMINE PIZANA, Scottville, MI (US); MARK R. KEYSER, Lake Orion, MI (US)

(21) Appl. No.: 16/394,664

(22) Filed: Apr. 25, 2019

(51) Int. Cl. B60N 2/02; B60R 21/013; B60R 21/055; B60N 2/20

(52) U.S. Cl. CPC B60N 2/0276; B60R 21/013; B60R 2021/0011; B60N 2/20; B60R 21/055

(57) ABSTRACT

A vehicle system for mitigating the effects of rear or front collisions includes a vehicle seat having a vehicle seat cushion and a vehicle seatback. The vehicle seatback is rotatable relative to the vehicle seat cushion. An actuation system adjusts the position of the vehicle seatback relative to the vehicle seat cushion or the vehicle seat cushion relative to the vehicle seatback. Characteristically, the vehicle system also includes a profile selector that receives vehicle seat contextual data and determines an actuation travel profile that is applied to the vehicle seatback via the actuation system in response to the vehicle seat contextual data indicating a collision triggering event.

### TECHNICAL FIELD

In at least one aspect, the present invention is related to vehicle seatback/seat cushion positioning systems for enhancing passenger safety.

### BACKGROUND

Improvements in vehicle safety continue to be an important design requirement. In particular, systems for avoiding collisions and/or mitigating the damage from such collisions are desirable. Examples of such systems are set forth in U.S. Pat. Nos. 6,420,996; 8,364,351; and 8,392,071 and in U.S. Pat. Pub. Nos. 2005/0131606 and 2013/0181860.

### SUMMARY

In at least one aspect, the present invention provides a vehicle system for mitigating a front or rear impact collision. The vehicle system includes a vehicle seat having a vehicle seat cushion and a vehicle seatback. The vehicle seatback is rotatable relative to the vehicle seat cushion. An actuation system adjusts the position of the vehicle seatback relative to the vehicle seat cushion or the vehicle seat cushion relative to the vehicle seatback (e.g., cushion lifts up). Characteristically, the vehicle system also includes a profile selector that receives vehicle seat contextual data and determines a travel profile that is applied to the vehicle seatback or the vehicle seat cushion via the actuation system in response to the vehicle seat contextual data indicating a collision triggering event (i.e., a rear collision triggering event or a front collision triggering event).

In another embodiment, a method for moving a vehicle seat for mitigating a front or rear impact collision is provided. The method includes a step of receiving vehicle contextual data. A travel profile is selected for rotating a vehicle seatback in response to vehicle seat contextual data indicating a rear collision triggering event or the vehicle seat cushion in response to vehicle seat contextual data indicating a front collision triggering event. The travel profile is applied to a vehicle seat such that a vehicle seatback rotates to a forward position fort the rear collision triggering event or the vehicle seat cushion is raised from its initial position for a front collision triggering event.

Advantageously, the vehicle systems and methods set forth herein minimize the perceived effect of rapid reposition of the vehicle seatback/seat cushion on the occupant. The systems and methods will trigger an actuation travel profile based on vehicle speed, current vehicle seatback/cushion position, occupant classification, rear seat occupancy, current adjuster position, and speed of the vehicle approaching from behind.

### BRIEF DESCRIPTION OF THE DRAWINGS

FIG. 1 is a schematic showing the operation of a vehicle rear/front impact mitigation system.

FIG. 2 is a schematic of a vehicle having a rear/front impact mitigation system.

FIG. 3 is a schematic of a rear/front impact mitigation system.

FIG. 4A provides a plot of vehicle seatback rotation versus time.

FIG. 4B provides a plot of motor rotations per minute (“RPM”) versus time and a plot of motor torque versus time.

FIG. 4C provides a plot of motor current draw versus time and a plot of motor voltage versus time.

FIG. 4D provides a plot of torque rod torque versus time and a plot of torque rod speed versus time.

FIG. 5 provides a flowchart depicting the method implemented by the system of FIGS. 1, 2, and 3.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

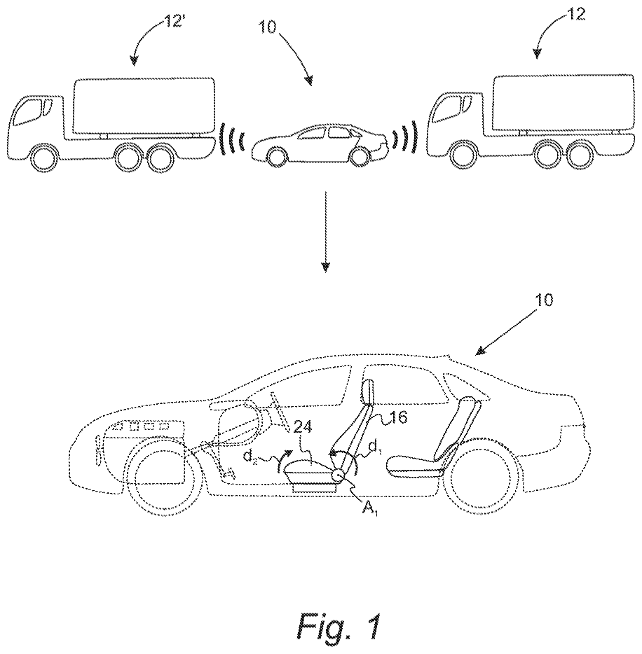

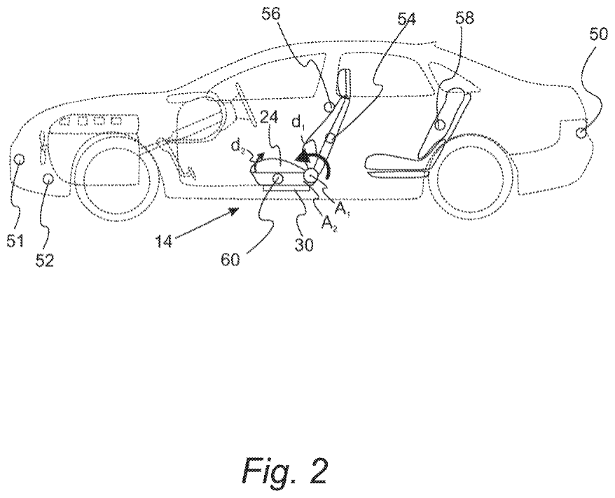

With reference to FIGS. 1 and 2, schematic illustrations showing an overview of the operation of a vehicle seat travel profile selection system that mitigates the effects of front and rear collisions is provided. Vehicle 10 senses the presence of an approaching vehicle 12. If the speed and distance of the rearwardly approaching vehicle meets certain criteria as set forth below, profile selection system 14 cause a travel profile to be executed and vehicle seatback 16 to pivot forward along direction di. In general, the basic task in responding to a rear collision is to rotate an occupied seatback forward a set number of degrees (e.g., about 9°) in a set amount of time as set forth below in more detail. The actuation is applied via a motor/gear box that rotates a torque rod which in turn rotates a vehicle seatback. The rotation is not simply on-off, but rather smoothly ramped up, and then quickly ramped down, to minimize starting and ending shock loads to both the occupant and motor gear train. The peak between acceleration and deceleration may also be clipped to include a constant velocity dwell period (e.g., about 50 ms) to allow the controller to more accurately transition between acceleration and deceleration to execute the desired pulse. FIGS. 1 and 2 also depict vehicle 10 sensing a potential front impact with vehicle 12′. As set forth below in more detail, in this scenario seat cushion 24 may lift up.

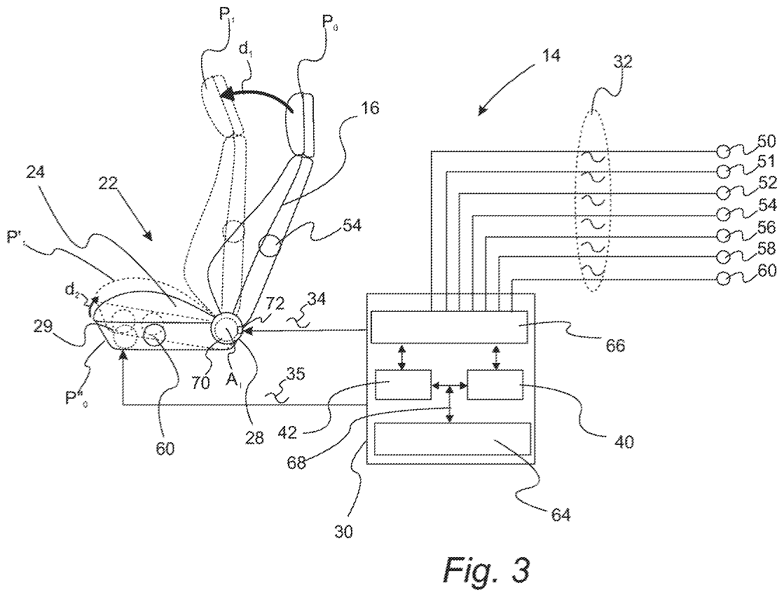

With reference to FIGS. 2 and 3, schematic illustrations of a vehicle seat travel profile selection system is provided. Vehicle seat profile selection system 14 includes vehicle seat 22 having vehicle seat cushion 24 and a vehicle seatback 16. Vehicle seatback 16 is pivotally mounted about vehicle seat cushion 24 allowing vehicle seatback 16 to pivot about axis A₁ along direction di relative to the vehicle seat cushion 24. Actuation system 28 adjusts the position of the vehicle seatback relative to the vehicle seat cushion 24. Similarly, actuations system 29 adjusts the position of vehicle seat cushion 24 (e.g., lifting up). In a refinement, the actuation systems 28 and 29 each independently includes a motor and a motor controller. The motor controller nearly instantaneously senses where the motor is, speed, position-wise over time, and provides instantaneous voltage as required to achieve the required instantaneous speed and position. It should be appreciated that motor speed is load and voltage dependent. Typically, the motor controller has a constant vehicle voltage applied to it and uses pulse width modulation to effectively apply variable voltage to the motor. In a refinement, the same motor/gear box and controller can be used for a comfort adjust function which is ˜8-10 times slower. In order to provide this latter feature, a brushless motor is used rather than just a simple DC permanent magnet brushed motor.

Still referring to FIGS. 2 and 3, vehicle seat profile selection system 14 also includes profile selector 30. Profile selector 30 receives vehicle seat contextual data 32 and determines an actuation travel profile 34 that is applied to the vehicle seatback 16 via the actuation system 28 in response to the vehicle seat contextual data indicating a rear collision triggering event. Similarly, profile selector 30 receives vehicle seat contextual data 32 and determines an actuation travel profile 35 that is applied to vehicle seat cushion 24 via the actuation system 29 in response to the vehicle seat contextual data indicating a front collision triggering event. In this regard, contextual data refers to parameters characterizing the state of the vehicle such as occupancy, current seat position, position and speed of vehicles surrounding the vehicle, and the like. In particular, actuation travel profile 34 results in the vehicle seatback 16 pivoting forward with respect to vehicle seat cushion 24 upon the occurrence of a rear collision triggering event. Similarly, actuation travel profile 35 results in the vehicle seat cushion 24 lifting upward (e.g., pivoting about axis A₁ or another axis A₂) upon the occurrence of a front collision triggering event. In a refinement, seatback 16 can pivot rearward (e.g., 3 to 100 about axis A₁) in response to a potential front collision.

In one variation, the collision triggering event indicates a potential collision or an impending collision (i.e., of a rear or forward nature). In this context, a potential collision means that the vehicle seat contextual data indicates that a collision is more probable than not (e.g., 50 to 90% percent probability of occurring). An impending collision means that the vehicle seat contextual data indicates that a collision is inevitable (e.g., over a 90% probability of occurring).

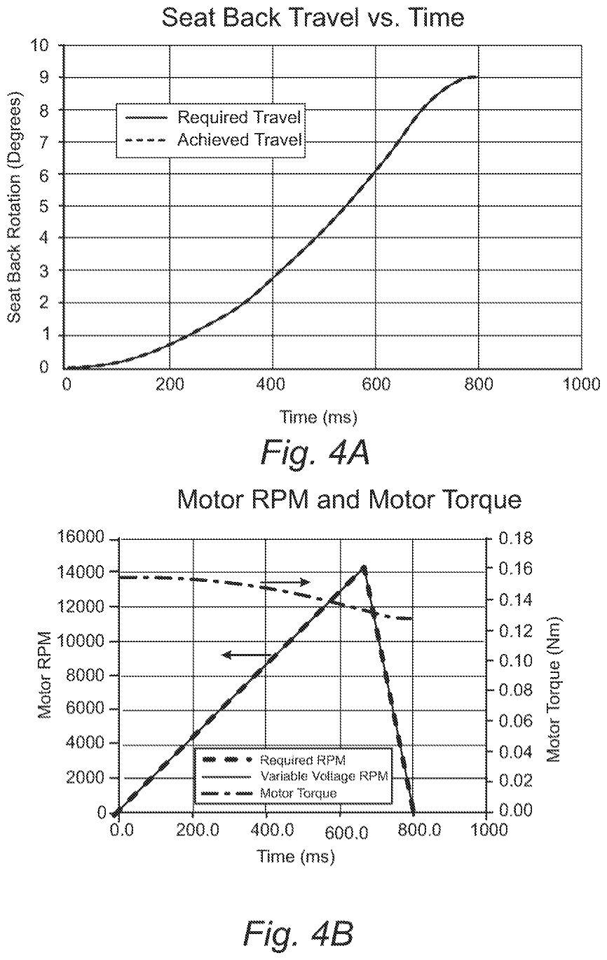

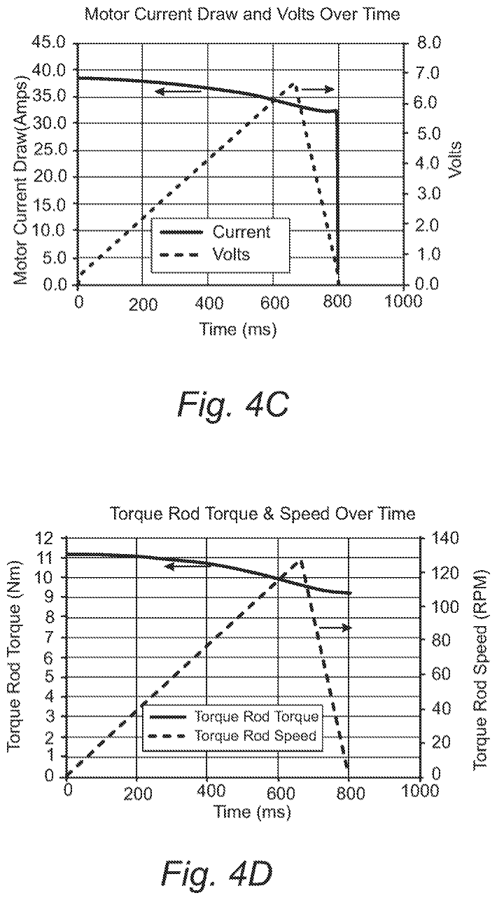

Characteristically, the vehicle seatback moves to the first forward position P₁ with a smooth vehicle seatback rotation versus time as depicted in FIG. 4A when a rear collision triggering event occurs. In a refinement, smooth rational speed means that the first derivative of the vehicle seatback rotation angle (i.e., the actuation angle) versus time is continuous at all points between the time tᵢ the rotation begins and the time t_{f} the rotation stops except the endpoint times tᵢ and t_{f}. Typically, vehicle seatback 16 is pivoted forward to first forward position P₁ through a first predetermined angle relative to initial position P₀ of the vehicle seatback 16 within a first predetermined time in anticipation of a potential rear collision or within a second predetermined time period in anticipation of the impending collision. Characteristically, the first predetermined time period is greater than second predetermined time period with the vehicle seatback moving to the forward position with a smooth rotational speed. The advantage of the “smooth rotational speed” is two-fold. 1) to minimize shock loads to the occupant, and 2) to minimize shock loads to the motor gear train. The initial position P₀ can be the design position or any position that the vehicle seatback happens to be currently positioned in prior to detection of the rear collision triggering event. In a refinement, the first predetermined angle is from 5 to 13 degrees. In a further refinement, the first predetermined time period is from 600 to 1200 ms and the second predetermined time period is from 200 to 600 ms.

Similarly, vehicle seat cushion 24 lifts upward when a front collision triggering event is detected. In a refinement, the front of the cushion lifts upward by pivoting of the seat cushion with respect to the seatback by a second predetermined angle. In a refinement, the second predetermined angle is from about 5 degrees to about 13 degrees relative to the seat cushions initial position P′ₒ. In a further refinement, the second predetermined angle is from 7 to 10 degrees. This positioning provides more “pocketing” of the occupant into the vehicle seat cushion, therefore minimizing occupant submarining, where the occupant slides forward underneath the seat belt in a forward crash event. In a refinement, vehicle seat cushion 24 is pivoted upward (relative to the vehicle floor) to first upward position P′₁ through a second predetermined angle relative to initial position P′₀ of the vehicle seat cushion 24 within a first predetermined time in anticipation of a potential front collision or within a second predetermined time period in anticipation of the impending collision. Characteristically, the first predetermined time period is greater than second predetermined time period with the vehicle seat cushion moving to the upward position with a smooth rotational speed. The initial position P′₀ can be the design position or any position that the vehicle seat cushion happens to be currently positioned in prior to detection of the front collision triggering event. In a further refinement, the first predetermined time period is from 600 to 1200 ms and the second predetermined time period is from 200 to 600 ms.

With reference to FIG. 3, profile selector 30 includes a data processing unit 40 that determines presence of a collision triggering event (e.g., rear or front) from the vehicle seat contextual data. Profile selector 30 can further include a controller 42 that applies and selects a suitable actuation travel profile for repositioning the vehicle seat from the vehicle seat contextual data.

With reference to FIGS. 2 and 3, the vehicle seat contextual data includes the speed of a vehicle approaching from behind the vehicle and the closing distance. Additional vehicle seat contextual data includes one or more or all of vehicle speed, current vehicle seatback position, occupant classification, rear seat occupancy, current seat adjuster position, and current seat adjuster position. Therefore, vehicle seat profile selection system 14 includes a plurality of sensors for determining this data. In this regard, vehicle seat profile selection system 14 includes a rear sensor 50 for detecting a vehicle approaching from behind and a front sensor 51 for detecting a front collision. Vehicle seat profile selection system 14 can also include one or more or all of vehicle speed sensor 52, current vehicle seatback position 54, occupant classification sensor 56, rear seat occupancy 58, and current seat adjuster position 60. Typically, a plurality of previously determined and/or collected actuation travel profiles is stored by profile selector 30 in a non-transitory memory storage device 64. Profile selector 30 can also include an input/output interface 66 that provides an interface between actuation system 28 and sensors 50-60. Similarly, actuation system 28 includes motor 70 and interface 72 which can actuate the motor.

With reference to FIGS. 4A, 4B, 4C, and 4D, plots of various motor parameters and seat rotation for a rear collision triggering event are provided. FIG. 4A provides a plot of vehicle seatback rotation versus time. This figure shows the smooth movement as set forth above from the time tᵢ the rotation begins to the time t_{f} the rotation stops. FIG. 4B provides a plot of motor rotations per minute (“RPM”) versus time and a plot of motor torque versus time. The motor torque is also observed to be smooth from the time tᵢ the rotation begins to the time t_{f} the rotation stops. However, this actuation travel profile is achieved by the RPMs increasing from 0 monotonically from the time tᵢ the rotation begins to an intermediate time tᵢₙₜ. The RPMs then decrease monotonically (e.g., linearly) to 0 from the intermediate time tᵢₙₜ to the time t_{f} the rotation stops. FIG. 4C provides a plot of motor current draw versus time and a plot of motor voltage versus time. The motor current draw is also observed to be smooth from the time tᵢ the rotation begins to the time t_{f} the rotation stops where it abruptly drops to 0. In contrast, the motor voltage increases (from 0 volts) monotonically from the time tᵢ the rotation begins to an intermediate time tᵢₙₜ. The voltage then decreases monotonically to 0 volts (e.g., linearly) from the intermediate time tᵢₙₜ to the time t_{f} the rotation stops. Finally, FIG. 4D provides a plot of torque rod torque versus time and a plot of torque rod speed versus time. The torque rod torque is also observed to be smooth from the time tᵢ the rotation begins to the time t_{f} the rotation stops. In contrast, the torque rod speed increases (from 0 volts) monotonically from the time tᵢ the rotation begins to an intermediate time tᵢₙₜ. The of torque rod speed then decrease monotonically to 0 volts (e.g., linearly) from the intermediate time tᵢₙₜ to the time t_{f} the rotation stops. In a refinement, the intermediate time tᵢₙₜ is within about 200 ms from the final time t_{f}.

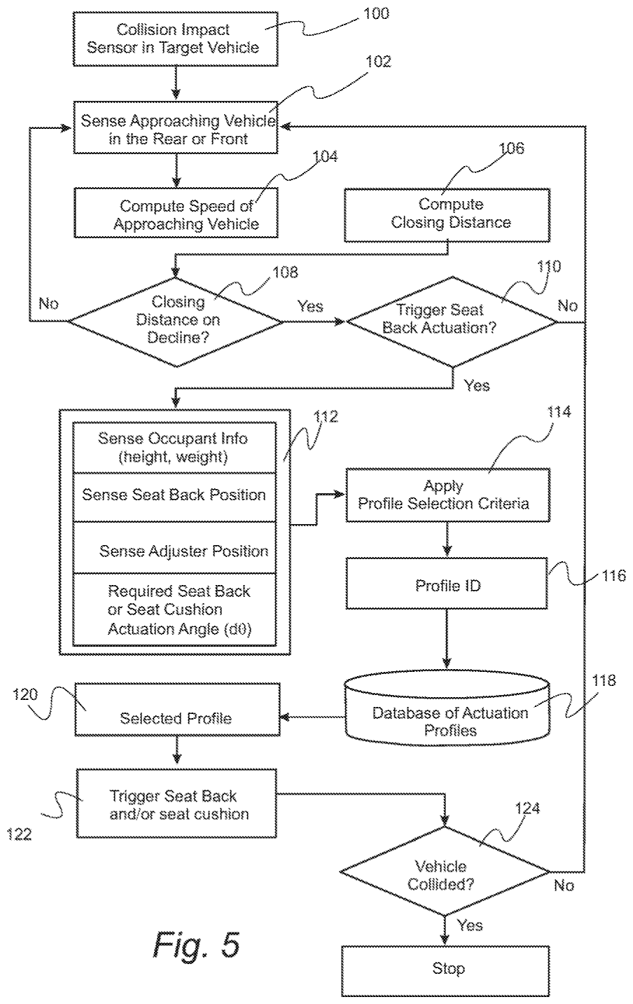

In another embodiment, a method implemented by the system set forth above is provided. In general, the method includes a step of receiving a rear or front collision triggering event. An actuation travel profile is selected for rotating a vehicle seatback in response to a vehicle seat contextual data indicating a collision triggering event. The actuation travel profile is applied to a vehicle seat such that a vehicle seatback rotates to a forward position from its initial position for a rear collision event. FIG. 5 provides a flowchart depicting the method implemented by the system set forth above. As depicted by box 100, the collision impact sensors are implemented in the vehicle seat profile selection system as set forth above. After an approaching vehicle is sensed by the rear impact sensor or by the front impact sensor (box 102), the speed of an approaching vehicle (box 104) and the closing distance (box 106) are computed. In the context of front collision detection, an approaching vehicle is a vehicle in front of the present vehicle (i.e., the vehicle deploying the collision detection system) on which the present vehicle is closing on since it is moving faster (since they are moving towards each other). As indicated by box 108, the system determines if the closing distance is decreasing. If the closing distance is not decreasing, the system returns to the operations of box 102 and monitors speeds of approaching vehicles. If the closing distance is decreasing, a determination is made if the vehicle seatback actuation should be triggered (box 110). Details for the criteria that can be applied to the step of box 110 are found in U.S. Pat. No. 10,239,420; the entire disclosure of which is hereby incorporated by reference. For example, a rear impact collision is imminent within 400 ms. or a rear impact collision potentially can occur within 800 ms. If it is determined that vehicle seatback actuation should not proceed, the system returns to the operations of box 102. If it is determined that actuation should proceed, the system proceeds to the operations of box 112 in which additional contextual data is determined by sensing occupant information (e.g., height, weight), vehicle seatback position, and adjuster position to determine the required seatback or vehicle seat cushion actuation angle actuation angle (dθ). It should be appreciated that the same speed and position for the seatback or the seat cushion over time is desired for every deployment regardless of seat system load. The load is extremely variable and is determined by several factors including occupant weight/stature, starting and ending seatback angle, and friction between the occupant and seat trim covers. Temperature also contributes. Some of these contributors can be sensed and quantified, and fed into the controller to pre-determine how much voltage over time to apply to the motor. In the next operations, travel profile selection criteria are applied (box 114), and a profile ID identified (box 116). The identified travel profile is then accessed from a database of predetermined actuation travel profiles or created by interpolation between existing profiles. As indicated by box 122, the vehicle seatback is triggered. If a collision has not occurred, the monitoring proceeds to the operations of box 102, otherwise the method stops (box 124).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle system comprising:
a vehicle seat having a vehicle seat cushion and a vehicle seatback, the vehicle seatback rotatable relative to the vehicle seat cushion;
an actuation system that adjusts a position of the vehicle seatback relative to the vehicle seat cushion for a rear collision triggering event and/or adjusts the position of the vehicle seat cushion relative to the vehicle seatback for a front collision triggering event; and
a profile selector that receives vehicle seat contextual data and determines an actuation travel profile that is applied to the vehicle seatback and/or seat cushion via the actuation system in response to the vehicle seat contextual data indicating the rear collision triggering event or the front collision triggering event.

2. The vehicle system of claim 1 wherein the rear collision triggering event and the front collision triggering event indicate either a potential collision or an impending collision.

3. The vehicle system of claim 2 wherein application of the actuation travel profile results in the vehicle seatback rotating forward with respect to the vehicle seat cushion when the rear collision triggering event indicates a potential collision or an impending rear collision.

4. The vehicle system of claim 3 wherein the vehicle seatback is rotated forward to a forward position within a first predetermined time period in anticipation of a potential rear collision or within a second predetermined time period in anticipation of the impending collision, the first predetermined time period greater than second predetermined time period, the vehicle seatback moving to the forward position with a smooth rotational speed.

5. The vehicle system of claim 4 wherein the vehicle seatback is rotated forward to a first predetermined angle relative to an initial position of the vehicle seatback in moving to the forward position.

6. The vehicle system of claim 5 wherein the first predetermined angle is from 5 to 13 degrees, the first predetermined time period is from 600 to 1200 ms and the second predetermined time period is from 200 to 600 ms.

7. The vehicle system of claim 2 wherein application of the actuation travel profile results in the vehicle seat cushion pivots upward by a second predetermined angle when the front collision triggering event indicates a potential front collision or an impending front collision.

8. The vehicle system of claim 7 the second predetermined angle is from about 7 to 10 degrees.

9. The vehicle system of claim 1 wherein the profile selector includes a data processing unit that determines presence of the rear collision triggering event or the front collision triggering event from the vehicle seat contextual data, the profile selector further includes a controller that applies and selects a suitable actuation travel profile for repositioning the vehicle seat from the vehicle seat contextual data.

10. The vehicle system of claim 1 wherein the vehicle seat contextual data includes speed of a vehicle approaching from behind.

11. The vehicle system of claim 10 wherein the vehicle seat contextual data further includes one or more or all of vehicle speed, current vehicle seatback position, occupant classification, rear seat occupancy, and current seat adjuster position.

12. The vehicle system of claim 1 wherein the actuation system further operable to pivot the vehicle seatback to a rearward position from its initial position.

13. A method for moving a vehicle seat for enhancing impact safety, the method comprising:
receiving vehicle contextual data;
selecting an actuation travel profile for rotating a vehicle seatback relative to a vehicle seat cushion in response to vehicle seat contextual data indicating a rear collision triggering event or rotating a vehicle seat cushion relative to a vehicle seatback in response to vehicle seat contextual data indicating a front collision triggering event or; and
applying the actuation travel profile to a vehicle seat such that the vehicle seatback rotates to a forward position from its initial position for a rear collision triggering event or the vehicle seat cushion is raised from its initial position for a front collision triggering event.

14. The method of claim 13 wherein if a sensed closing distance is decreasing, a determination is made if seat back actuation should be triggered, if it is determined that actuation should proceed, additional contextual data is sensed which includes occupant information, seat back position, and adjuster position such that a required vehicle seatback actuation angle is determined.

15. The method of claim 14 wherein profile selection criteria is applied and a profile ID identified such that an identified actuation travel profile is then accessed from a database of predetermined actuation profiles or created by interpolation between existing profiles.

16. The method of claim 14 wherein application of the actuation travel profile results in the vehicle seatback rotating forward with respect to the vehicle seat cushion.

17. The method of claim 13 wherein the rear collision triggering event or the front collision triggering event indicates either a potential collision or an impending collision.

18. The method of claim 17 wherein the vehicle seatback is rotated forward to a forward position within a first predetermined time period in anticipation of a potential rear collision or within a second predetermined time period in anticipation of the impending collision, the first predetermined time period greater than second predetermined time period, the vehicle seatback moving to the forward position with a smooth rotational speed.

19. The method of claim 18 wherein the first predetermined time period is from 600 to 1200 ms and the second predetermined time period is from 200 to 600 ms.

20. The method of claim 18 the vehicle seat cushion pivots upward by a second predetermined angle when the rear collision triggering event indicates a potential collision or an impending front collision, the second predetermined angle being from about 7 to 10 degrees.
